(19) United States
(12) Patent Application Publication
(10) Pub. No.: US 2013/0257775 A1
(43) Pub. Date: Oct. 3, 2013

(54) ELECTRONIC DEVICE AND METHOD FOR OUTPUTTING IMAGE THEREOF

(71) Applicant: SAMSUNG ELECTRONICS CO., LTD, Gyeonggi-do (KR)

(72) Inventor: Yong-Seok Lee, Gyeonggi-do (KR)

(73) Assignee: Samsung Electronics Co., Ltd, Gyeonggi-do (KR)

(21) Appl. No.: 13/855,509

(22) Filed: Apr. 2, 2013

(30) Foreign Application Priority Data
Apr. 2, 2012 (KR) 10-2012-0033997

(51) Int. Cl. G06F 3/041

(52) U.S. Cl. CPC G06F 3/0416
USPC 345/173

(57) ABSTRACT

A method outputs an image in an electronic device. In the method, transformation of a flexible display screen is detected. A width of an image appearing on the flexible display screen is increased or reduced.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Apr. 2, 2012 and assigned Serial No. 10-2012-0033997, the entire disclosure of which is hereby incorporated by reference.

### TECHNICAL FIELD

The present disclosure relates to an electronic device having a flexible display and a method for outputting an image thereof.

### BACKGROUND

Recently, an interest in an electronic device that employs a flexible display increases. The flexible display plays a role in leading a field which has been limited to the conventional display. For example, a new field such as an electronic book field that can replace publication such as magazines, and an ultra-miniature Personal Computer (PC) that can fold or roll a display and carry the same, etc. is becoming a utilization field of the flexible display.

FIGS. 1A-B illustrates an image recognized by a user depending on transformation of the conventional flexible display screen. Referring to FIGS. 1A-B, in the case where the conventional flexible display screen 10 is transformed, an image 11 on the flexible display screen 10 appears distorted to a user (21). Although the flexible display has an advantage that it may be transformed, this transformation provides a distorted image to a user, so that the user cannot receive correct visual information.

### SUMMARY

To address the above-discussed deficiencies of the prior art, it is a primary object to provide at least the advantages described below. Accordingly, an aspect of the present disclosure is to provide an electronic device for providing correct visual information to a user by compensating for distortion of an image in the case where a flexible display screen is transformed, and a method for outputting an image thereof.

Another aspect of the present disclosure is to provide an electronic device for increasing or decreasing the width of an image depending on transformation of a flexible display screen, for example, extension, shrinkage, warping, folding, twisting, bending, etc., and a method for outputting an image thereof.

In accordance with an aspect of the present disclosure, a method for outputting an image in an electronic device is provided. The method includes detecting transformation of a flexible display screen, and increasing or reducing a width of an image appearing on the flexible display screen.

In accordance with another aspect of the present disclosure, an electronic device is provided. The electronic device includes a transformable flexible display screen, at least one processor, a memory, a sensor for providing transformation information of the flexible display screen to the at least one processor, and at least one module stored in the memory and configured for being executable by the at least one processor, wherein the module increases or reduces a width of an image appearing on the flexible display screen depending on the transformation information of the flexible display screen.

Other aspects, advantages and salient features of the disclosure will become apparent to those skilled in the art from the following detailed description, which, taken in conjunction with the annexed drawings, discloses exemplary embodiments of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A-B illustrate an image recognized by a user depending on transformation of the conventional flexible display screen;

FIG. 2 illustrates an electronic device according to an exemplary embodiment of the present disclosure;

FIG. 3A illustrates a method for outputting an image depending on transformation of the conventional flexible display screen;

FIG. 3B illustrates a method for outputting an image depending on transformation of a flexible display screen according to an exemplary embodiment of the present disclosure;

FIG. 4 illustrates a flowchart of a procedure for outputting an image according to an exemplary embodiment of the present disclosure;

FIG. 5 illustrates a flowchart of step 403 of FIG. 4 for increasing or reducing a width of an image in the case where a screen transforms according to an exemplary embodiment of the present disclosure; and

FIGS. 6A-B illustrate an image recognized by a user depending on transformation of a flexible display screen according to an exemplary embodiment of the present disclosure.

Throughout the drawings, like reference numerals will be understood to refer to like parts, components and structures.

### DETAILED DESCRIPTION

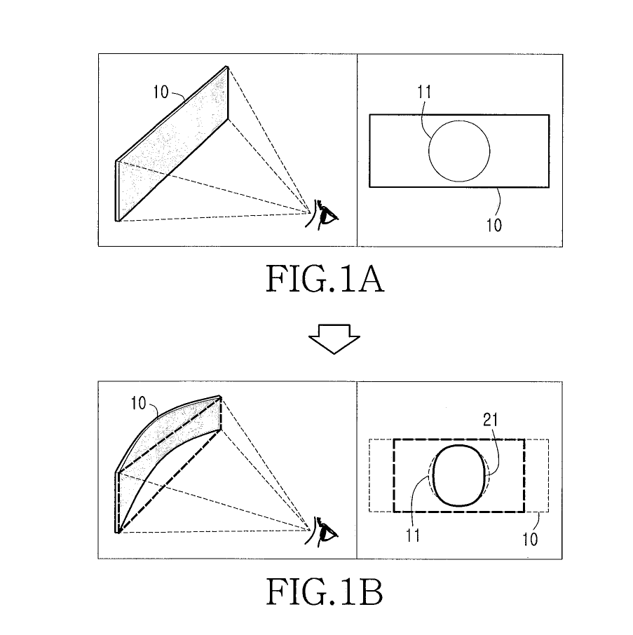

FIGS. 1A through 6B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device. The following description with reference to the accompanying drawings is provided to assist in a comprehensive understanding of exemplary embodiments of the disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the disclosure. Also, descriptions of well-known functions and constructions are omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of exemplary embodiments of the present disclosure are provided for illustration purpose only and not for the purpose of limiting the disclosure as defined by the appended claims and their equivalents.

Exemplary embodiments of the present disclosure provide a flexible display screen. The flexible display screen denotes a portion of an image device where an image is displayed. The flexible display screen allows transformation such as extension, shrinkage, warping, folding, twisting, bending, unfolding, etc. An image outputting apparatus according to an exemplary embodiment of the present disclosure controls an image output depending on the transformation. An electronic device and a method for outputting an image thereof according to an exemplary embodiment of the present disclosure compensate for distortion of an image in the case where the flexible display screen is transformed, and provides correct visual information to a user. Also, a method and an apparatus for outputting an image in an electronic device according to an exemplary embodiment of the present disclosure increases or reduces the width of an image depending on transformation of the flexible display screen, for example, extension, shrinkage, warping, folding, twisting, etc.

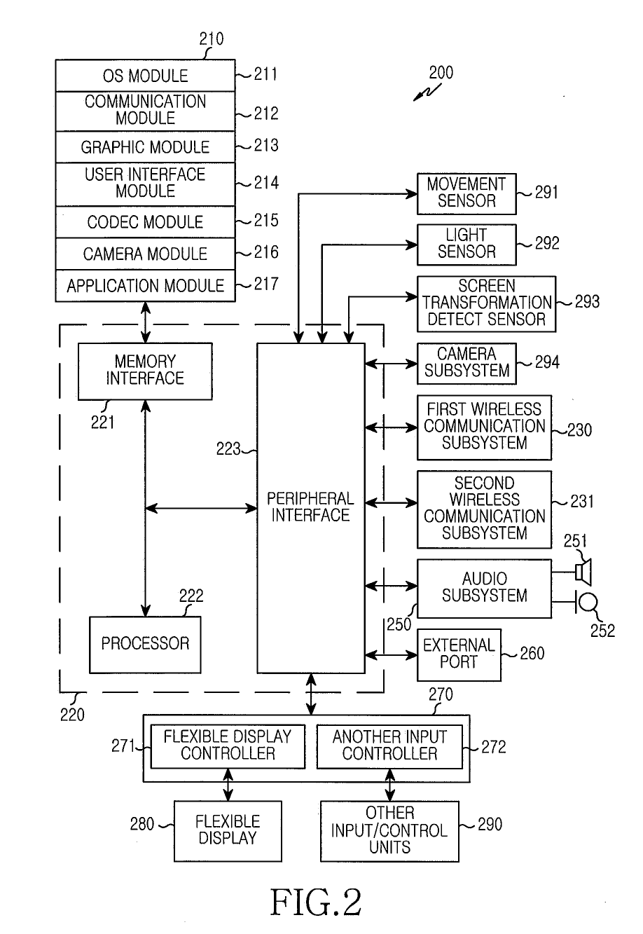

FIG. 2 illustrates an electronic device according to an exemplary embodiment of the present disclosure. The electronic device 200 may be a device such as a portable electronic device, a portable terminal, a mobile phone, a mobile pad, a media player, a tablet computer, a handheld computer, and a Personal Digital Assistant (PDA). Also, the electronic device 200 may be an arbitrary electronic device including a device combining two or more functions among these devices.

The electronic device 200 includes a memory 210, a processor unit 220, a first wireless communication subsystem 230, a second wireless communication subsystem 231, an external port 260, an audio subsystem 250, a speaker 251, a microphone 252, an Input/Output (I/O) subsystem 270, a flexible display 280, and another input or control unit 290. A plurality of memories 210 and external ports 260 may be provided.

The processor unit 220 includes a memory interface 221, one or more processors 222, and a peripheral interface 223. The entire processor unit 220 may be called a processor. The memory interface 221, one or more processors 222, and/or the peripheral interface 223 may be separate elements or configured in one or more integrated circuits.

The processor 222 executes various software programs to perform various functions for the electronic device 200, and performs a process and a control for voice communication, video communication, and data communication. Also, in addition to these general functions, the processor 222 executes a software module (instruction set) stored in the memory 210 to perform various functions corresponding to the module. Also, in addition to these general functions, the processor 222 may execute a specific software module (instruction set) stored in the memory 210 to perform various functions corresponding to the module. That is, the processor 222 performs a method of an embodiment of the present disclosure in cooperation with software modules stored in the memory 210.

The processor 222 may include one or more data processors, image processors, or a CODEC. In the electronic device 200, the data processors, the image processors, or the CODEC may be configured as separate elements. The peripheral interface 223 connects the I/O subsystem 270 of the electronic device 200 and various peripheral devices to the processor 222. Furthermore, the peripheral interface 223 connects the I/O subsystem 270 of the electronic device 200 and various peripheral devices to the memory 210 via the memory interface 221.

Various elements of the electronic device 200 may be connected via one or more communication buses (reference numeral not shown) or stream lines (reference numeral not shown).

The external port 260 directly connects the electronic device 200 to another electronic device or indirectly connects the electronic device 200 to another electronic device via a network (for example, the Internet, an Intranet, a wireless LAN, etc.). For example, the external port 260 denotes a Universal Serial Bus (USB) port, or a FIREWIRE port, etc., and is not limited thereto.

A movement sensor 291, a light sensor 292, and a screen transformation detect sensor 293 are connected to the peripheral interface 223 to enable various functions. For example, the movement sensor 291 and the light sensor 292 may be connected to the peripheral interface 223 to detect the movement of the electronic device 200 or detect external light.

Particularly, the screen transformation detect sensor 293 may detect one of transformation of the screen of the flexible display 280, for example, extension, shrinkage, warping, folding, twisting, bending, and unfolding. Furthermore, the screen transformation detect sensor 293 may measure a degree of the transformation such as the warping, the folding, the twisting, the bending, and the unfolding. For example, in the case where the screen of the flexible display 280 is warped round, the screen transformation detect sensor 293 may calculate a tangential slope with respect to each coordinate of the screen. The processor 222 controls a flexible display controller 271 depending on the tangential slope of each coordinate, and the flexible display controller 271 controls an image output of the flexible display 280. Besides, other sensors such as a position sensor, a temperature sensor, and a living body sensor, etc. may be connected to the peripheral interface 223 to perform relevant functions.

A camera subsystem 294 may perform a camera function such as photographing, video clip recording, etc. The light sensor 292 may be a Charged Coupled Device (CCD) or a Complementary Metal Oxide Semiconductor (CMOS) device for the camera subsystem 294.

The first and second wireless communication subsystems 230 and 231 enable communication. The first and second wireless communication subsystems 230 and 231 may include a Radio Frequency (RF) receiver and transceiver and/or a light (for example, infrared) receiver and transceiver. The first communication subsystem 230 and the second communication subsystem 231 may be classified depending on a communication network. For example, the first communication subsystem 230 and the second communication subsystem 231 may be designed to operate via one of a Global System for Mobile Communication (GSM) network, an Enhanced Data GSM Environment (EDGE) network, a Code Division Multiple Access (CDMA) network, a W-Code Division Multiple Access (W-CDMA) network, a Long Term Evolution (LTE) network, an Orthogonal Frequency Division Multiple Access (OFDMA) network, a Wireless Fidelity (Wi-Fi) network, a WiMax network and/or a Bluetooth network.

The audio subsystem 250 is connected to a speaker 251 and a microphone 252 to take charge of input/output of an audio such as voice recognition, voice duplication, digital recording, a communication function, etc. That is, the audio subsystem 250 communicates with a user via the speaker 251 and the microphone 252. The audio subsystem 250 receives a data signal via the peripheral interface 223 of the processor unit 220, converts the received data signal to an electrical signal, and provides the converted electric signal to the speaker 251. The speaker 251 converts an electric signal to a sound wave audible by a human being. The microphone 252 converts a sound wave transferred from a human being or other sound sources to an electric signal. The audio subsystem 250 receives an electric signal from the microphone 252, converts the received electric signal to an audio data signal, and transmits the converted audio data signal to the peripheral interface 223. The audio subsystem 250 may include an attachable and detachable earphone, a head phone, or a head set.

The I/O subsystem 270 includes a flexible display controller 271 and/or another input controller 272. The flexible display 280 allows at least one of transformations of extension, shrinkage, warping, folding, twisting, bending, and unfolding. The flexible display controller 271 is connected to the flexible display 280 and controls an image output depending on transformation of the flexible display 280. The flexible display 280 and the flexible display controller 271 may further apply an arbitrary multi-touch detect technology including other proximity sensor arrangements or other elements as well as capacitive, resistive, infrared, and surface acoustic wave technologies. Another input controller 272 may be coupled to the other input/control units 290. The other input/control units 290 may include at least one of a push button, a rocker button, a rocker switch, a thumb wheel providing a relevant function, a dial, a stick, and a pointer device such as a stylus.

The flexible display 280 provides an input/output interface between the electronic device 200 and a user. For example, the flexible display 280 applies a touch detect technology, transfers a user's touch input to the electronic device 200, and shows visual information (for example, text, graphics, video, etc.) provided from the electronic device 200 to the user.

The memory 210 is connected to the memory interface 221, and includes a high speed random access memory such as one or more magnetic disk storages and/or a non-volatile memory, one or more optical storages, and/or a flash memory (for example, NAND, NOR).

The memory 210 stores program code for a software program. The software program includes an operating system module 211, a communication module 212, a graphic module 213, a user interface module 214, a CODEC 215, a camera module 216, and one or more application modules 217. The terminology ‘module’ is expressed as a set of instructions, or an instruction set, or a program.

The Operating System (OS) software 211 denotes WINDOWS, LINUX, Darwin, RTXC, UNIX, OS X, or a built-in operating system such as VxWorks, and includes various software elements for controlling a general system operation. Control of the general system operation includes memory management and control, storage hardware (device) control and management, power control and management, etc. Furthermore, the operating system software also performs a function for swift communication between various hardware (devices) and software elements (modules).

The communication module 212 may enable communication with a counterpart electronic device such as a computer, a server, a portable terminal, etc. via the wireless communication subsystems 230 and 231 or the external port 260.

The graphic module 213 includes various software elements for providing and displaying graphics on the flexible display 280. The terminology ‘graphics’ denotes text, a web page, an icon, a digital image, a video, an animation, etc.

The user interface module 214 includes various software elements related to a user interface. Furthermore, the user interface module 214 includes content regarding how a state of the user interface changes and a condition under which the state of the user interface changes.

The CODEC module 215 includes a software element related to encoding and decoding of a video file.

The camera module 216 includes a camera related software element enabling camera related processes and functions.

The application module 217 includes a browser, an e-mail, an instant message, word processing, keyboard emulation, an address book, a touch list, a widget, Digital Right Management (DRM), voice recognition, voice duplication, a position determining function, a location based service, etc. The memory 110 may further include an additional module (instructions) besides the above modules.

Also, various functions of the electronic device 200 according to the present disclosure may be executed by one or more stream processes and/or hardware including an Application Specific Integrated Circuit (ASIC) and/or software, and/or a combination of these.

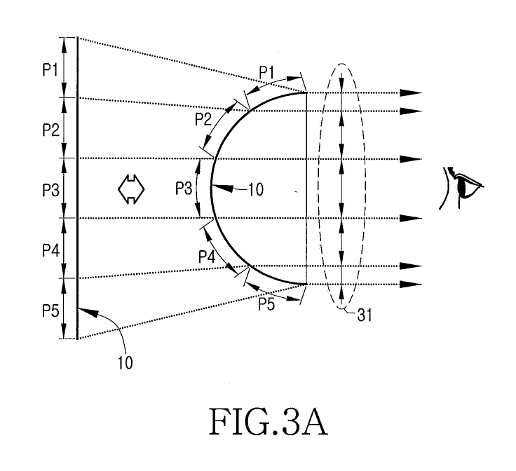

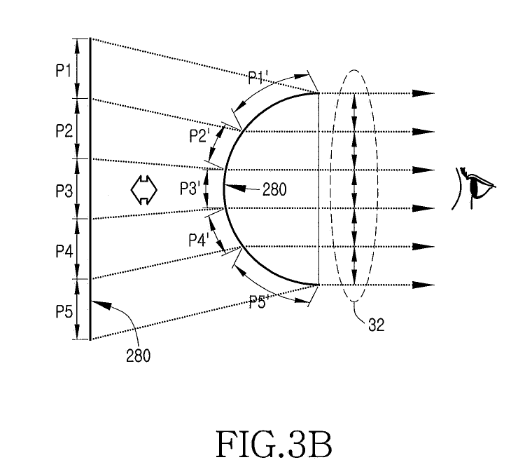

FIG. 3A illustrates a method for outputting an image depending on transformation of the conventional flexible display screen, and FIG. 3B illustrates a method for outputting an image depending on transformation of a flexible display screen according to an exemplary embodiment of the present disclosure.

Referring to FIG. 3A, the conventional flexible display screen 10 is divided into partial screens P1 to P5 of the same size. In the case where respective images of the partial screens P1 to P5 merge, an entire image viewed by a user is formed. In the case where the conventional flexible display screen 10 is warped round, the images of the partial screens P1 to P5 do not enter the user's eyes uniformly (31), so that the entire image appears distorted to the user (e.g., as illustrated in FIGS. 1A-B).

Referring to FIG. 3B, the flexible display screen 280 according to an embodiment of the present disclosure is divided into partial screens P1 to P5 of the same size when the flexible display screen 280 is flat. Respective images of the partial screens P1 to P5 merge, an entire screen viewed by a user is formed. In the case where the flexible display screen 280 according to an embodiment of the present disclosure is warped round, the sizes of the partial screens P1 to P5 change relatively. For example, when the size of a first partial screen increases, a second partial screen reduces relatively. When the size of the partial screen increases, the width of the image appearing on the partial screen increases. When the size of the partial screen reduces, the width of the image appearing on the partial screen reduces. On the contrary, when the flexible display screen transforms to a flat shape from the state where the flexible display screen is warped round, the flexible display screen is reconfigured as the partial screens of the same size. A degree by which the sizes of the partial screens are controlled relatively changes depending on a transformation degree of the flexible display screen 280, which is described with reference to the drawing below. Since the sizes of the partial screens change relatively, the images of the partial screens P1′ to P5′ whose size has been reconfigured enter a user's eyes (32), so that an entire image does not appear distorted to the user.

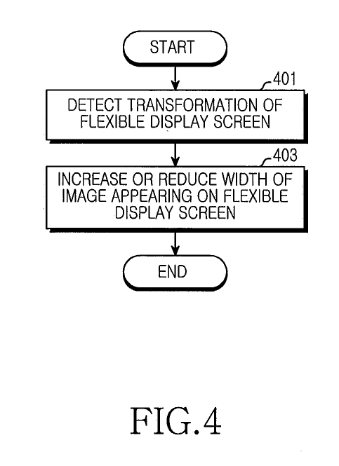

FIG. 4 illustrates a flowchart of a procedure for outputting an image according to an exemplary embodiment of the present disclosure.

The screen transformation detect sensor 293 provides transformation information of the flexible display to the at least one processor 222, and the processor 222 executes at least one module stored in the memory 210.

Referring to FIG. 4, the processor 222 detects transformation of the flexible display screen using the screen transformation detect sensor 293 (step 401).

Next, the processor 222 increases or reduces the width of an image appearing on the flexible display screen (step 403).

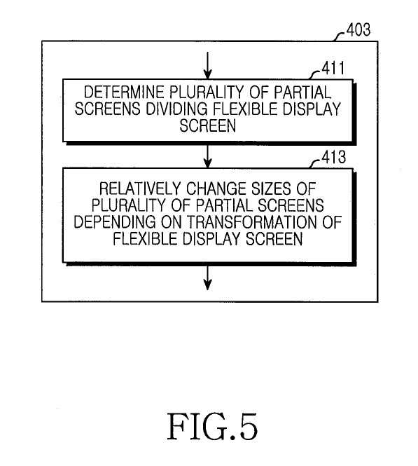

FIG. 5 illustrates a flowchart of step 403 of FIG. 4 for increasing or reducing a width of an image in the case where a screen is transformed according to an exemplary embodiment of the present disclosure.

Referring to FIG. 5, the processor 222 determines a plurality of partial screens dividing the flexible display screen (step 411).

Next, the processor 222 relatively changes the sizes of the plurality of partial screens dividing the flexible display screen depending on transformation of the flexible display screen (step 413). For example, in the case where the flexible display screen is transformed, the processor 222 calculates an average slope absolute value of the plurality of partial screens dividing the flexible display screen, and relatively changes the sizes of the partial screens depending on the calculated average slope absolute value. When an average slope absolute value of a first partial screen among the plurality of partial screens dividing the flexible display screen is relatively greater than that of a second partial screen, the size of the first partial screen increases and the size of the second partial screen reduces. When the size of the first partial screen increases, the width of an image appearing on the first partial screen increases. When the size of the second partial screen reduces, the width of an image appearing on the second partial screen reduces. In the case where the flexible display screen is transformed, an average slope of the divided partial screens may be calculated via the screen transformation detect sensor 293. When the flexible display screen is transformed, the screen transformation detect sensor 293 provides a spatial coordinate, and can calculate an average slope absolute value of the plurality of partial screens dividing the flexible display screen with reference to the spatial coordinate.

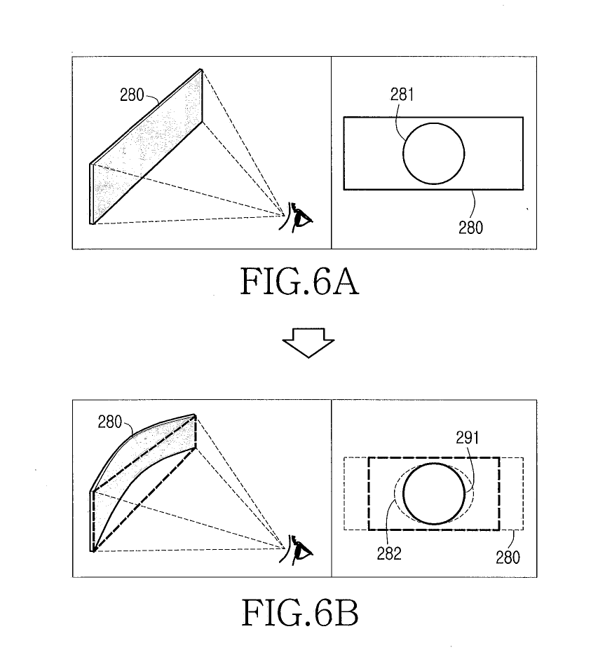

FIGS. 6A-B illustrate an image recognized by a user depending on transformation of a flexible display screen according to an exemplary embodiment of the present disclosure. Referring to FIGS. 6A-B, in the case where the flexible display screen 280 is warped round, the electronic device 200 increases an image 281 on the flexible display screen 280 before the warping and outputs the same (282). Accordingly, the increased image 282 enters a user's eyes, and can be transferred as an undistorted image 291 to the user. In the case where the flexible display screen 280 is warped round, the image 291 viewed by the user has a smaller size than the image 281 on the flexible display screen 280 before the warping, but the shape is not distorted and is similar to the original shape.

Methods according to embodiments described in claims and/or specification of the present disclosure may be implemented in the form of hardware, software, or a combination of the hardware and the software.

In case of implementation in software, a computer readable storage medium that stores one or more programs (software modules) may be provided. One or more programs stored in the computer readable storage medium are configured for execution by one or more processors inside an electronic device. One or more programs include instructions for allowing the electronic device to execute methods according to the embodiments described in claims and/or specification of the present disclosure.

The program (software module) may be stored in a random access memory, a non-volatile memory including a flash memory, Read Only Memory (ROM), Electrically Erasable Programmable Read Only Memory (EEPROM), a magnetic disc storage device, Compact Disc-ROM (CD-ROM), Digital Versatile Discs (DVDs) or other types of optical storage device, and a magnetic cassette. Alternatively, the program may be stored in a memory configured by a combination of all or a portion of these. Also, a plurality of memories may be provided.

Although the disclosure has been shown and described with reference to certain exemplary embodiments thereof, it will be understood by those skilled in the art that various changes in form and details may be made therein without departing from the spirit and scope of the disclosure as defined by the appended claims and their equivalents. Therefore, the scope of the present disclosure should not be limited to the above-described embodiments but should be determined by not only the appended claims but also the equivalents thereof.

A method and an apparatus for outputting an image in an electronic device can provide correct visual information to a user even when a flexible display screen is transformed.

What is claimed is:

1. A method for outputting an image in an electronic device, the method comprising:
detecting transformation of a flexible display screen; and
modifying a width of an image displayed on the flexible display screen.

2. The method of claim 1, wherein the transformation of the flexible display screen comprises at least one of extension, shrinkage, warping, folding, twisting, bending, or unfolding.

3. The method of claim 1, wherein modifying the width of the image displayed on the flexible display screen comprises:
changing a degree of increasing or reducing the width of the image depending on a degree of transformation of the flexible display screen.

4. The method of claim 1, wherein modifying the width of the image displayed on the flexible display screen comprises:
determining a plurality of partial screens dividing the flexible display screen; and
relatively changing sizes of the plurality of partial screens depending on the transformation of the flexible display screen.

5. The method of claim 4, wherein modifying the width of the image displayed on the flexible display screen comprises:
if a size of at least one partial screen among the plurality of partial screens increases, increasing a width of an image displayed on the partial screen; and
if the size of the at least one partial screen among the plurality of partial screens reduces, reducing the width of the image displayed on the partial screen.

6. The method of claim 4, wherein modifying the width of the image displayed on the flexible display screen comprises:
calculating an average slope absolute value of the plurality of partial screens dividing the flexible display screen; and
relatively changing sizes of the partial screens depending on the calculated average slope absolute value.

7. The method of claim 6, wherein modifying the width of the image displayed on the flexible display screen comprises:
when an average slope absolute value of a first partial screen among the plurality of partial screens dividing the flexible display screen is greater than an average slope absolute value of a second partial screen, increasing a size of the first partial screen and reducing a size of the second partial screen.

8. The method of claim 6, wherein modifying the width of the image displayed on the flexible display screen comprises:
providing a spatial coordinate depending on the transformation of the flexible display screen; and
calculating the average slope absolute value of the plurality of partial screens dividing the flexible display screen with reference to the spatial coordinate.

9. An electronic device comprising:
a transformable flexible display screen;
at least one processor;
a memory;
a sensor configured to provide transformation information of the flexible display screen to the at least one processor; and
at least one module stored in the memory and configured for being executable by the at least one processor,
wherein the electronic device is configured to modify a width of an image displayed on the flexible display screen depending on the transformation information of the transformable flexible display screen.

10. The electronic device of claim 9, wherein the sensor is configured to detect transformation of at least one of extension, shrinkage, warping, folding, twisting, bending, or unfolding of the transformable flexible display screen.

11. The electronic device of claim 9, wherein in modifying the width of the image displayed on the transformable flexible display screen, the electronic device is configured to change a degree of increasing or reducing the width of the image depending on a degree of transformation of the transformable flexible display screen.

12. The electronic device of claim 9, wherein in modifying the width of the image displayed on the transformable flexible display screen, the electronic device is configured to determine a plurality of partial screens dividing the transformable flexible display screen, and relatively change sizes of the plurality of partial screens depending on the transformation information of the transformable flexible display screen.

13. The electronic device of claim 12, wherein if a size of at least one partial screen among the plurality of partial screens increases, the electronic device is configured to increase a width of an image displayed on the partial screen, and
if the size of the at least one partial screen among the plurality of partial screens reduces, the electronic device is configured to reduces the width of the image displayed on the partial screen.

14. The electronic device of claim 9, wherein the electronic device is configured to calculate an average slope absolute value of a plurality of partial screens dividing the transformable flexible display screen depending on the transformation of the transformable flexible display screen, and
when increasing or reducing the width of the image displayed on the flexible display screen, the electronic device is configured to relatively change sizes of the partial screens depending on the average slope absolute value.

15. The electronic device of claim 14, wherein when an average slope absolute value of a first partial screen among the plurality of partial screens dividing the flexible display screen is greater than an average slope absolute value of a second partial screen, the electronic device is configured to increases a size of the first partial screen and reduce a size of the second partial screen.

16. The electronic device of claim 14, wherein the sensor is configured to obtain a spatial coordinate depending on the transformation of the transformable flexible display screen, and wherein the electronic device is configured to calculate the average slope absolute value of the plurality of partial screens dividing the transformable flexible display screen with reference to the spatial coordinate.

17. An apparatus comprising:
a flexible display screen;
a sensor configured to detect transformation of the flexible display screen; and
a controller configured to modify a size of an image displayed on the flexible display screen based on the transformation of the flexible display screen.

18. The apparatus of claim 17, wherein the transformation is at least one of at least one of extension, shrinkage, warping, folding, twisting, bending, or unfolding of the flexible display screen.

19. The apparatus of claim 17, wherein in modifying the size of the image displayed on the flexible display screen, the controller is configured to change a degree of the size of the image depending on a degree of the transformation of the flexible display screen.

20. The apparatus of claim 17, wherein in modifying the width of the image appearing on the flexible display screen, the controller is configured to identify a plurality of partial screens included in the flexible display screen, and relatively change sizes of the partial screens based on the transformation of the flexible display screen.
